(19) United States
(12) Patent Application Publication
(10) Pub. No.: US 2021/0146289 A1
(43) Pub. Date: May 20, 2021

(54) BAGHOUSE FILTER REVERSE PULSE CLEANING POSITION AND ACTIVATION SYSTEM

(71) Applicant: Kice Industries, Inc., Wichita, KS (US)

(72) Inventors: Seth Langston, Park City, KS (US); Jerry Spivey, Wichita, KS (US)

(21) Appl. No.: 16/951,075

(22) Filed: Nov. 18, 2020

Related U.S. Application Data
(60) Provisional application No. 62/936,649, filed on Nov. 18, 2019.

(51) Int. Cl. B01D 46/00; B08B 13/00; B08B 5/02; B01D 46/02; B01D 46/46

(52) U.S. Cl. CPC B01D 46/0064; B08B 13/00; B01D 46/46; B01D 46/023; B08B 5/02

(57) ABSTRACT

A system and method of positioning and activating a rotating manifold for a filtration system that more precisely injects pressurized air into filter elements without being prone to getting out of sync and that can be more easily adjusted or calibrated without having an individual enter the filtration system. The system can generally comprise a rotating cleaning manifold, a shaft encoder, a position switch, and a controller. The shaft encoder can be configured to sense an angular position and output a first positional data value. The position switch can be configured to sense a complete revolution and output a second positional data value. The controller can be configured to receive the first positional data value and the second positional data value and cause the output of at least one signal via an output module to activate an intermittent cleaning pulse.

### CROSS-REFERENCE TO RELATED APPLICATIONS

This application claims priority to U.S. Provisional Patent Application No. 62/936,649, filed Nov. 18, 2019, to Seth Langston and Jerry Spivey, entitled “Baghouse Filter Reverse Pulse Cleaning Position and Activation System,” currently pending, the entire disclosure of which, including the specification and drawings, is incorporated herein by reference.

### FIELD OF INVENTION

The present invention relates generally to industrial baghouses and, more particularly, to a positioning and activation system for a rotating cleaning manifold and cleaning process used in reverse pulse baghouses.

### BACKGROUND OF THE INVENTION

Various industrial and manufacturing processes that utilize gases can require industrial filtration of dust-laden or particulate-laden gases, known as “dirty gas.” Such industrial gas filtration processes can utilize baghouses. Certain baghouses, known as “reverse baghouses,” generally comprise various arrays of suspended filter elements, which generally comprise high-temperature fabric filter bags with wire cage reinforcement. Reverse baghouses typically comprise a lower chamber in communication with an upper chamber via the filter elements. The filter elements can be suspended in the lower chamber, and the open ends or mouths of the filter elements can be in communication with the upper chamber. The dirty gas can be pushed or drawn, via a blower or fan, into the lower chamber. In operation, the dirty gas can then pass through the fabric walls of the filter elements and be delivered as clean gas to the upper chamber through the mouths of the filter elements. As the dirty gas passes through the fabric walls of the filter elements into the interior of the filter elements, the dust or particulate matter of the dirty gas can accumulate or cake on the outer surface of the filter elements. When the dust or particulate matter build ups on the outer surface of the filter elements, it can reduce or prevent the flow of dirty gas through the fabric walls of the filter elements and inhibit the overall performance of the baghouse. As a result, it can be necessary to clean the filter elements by removing the accumulated dust or particulate matter that has built up on the outer surface of the filter elements.

There are various methods for cleaning filter elements. One method of cleaning the filter elements of a reverse baghouse is to blow pressurized air in a reverse direction through the bag walls (i.e., from the interior of the filter elements through the walls of the filter elements into the lower chamber). This cleaning method can be achieved by injecting pressurized air into the mouths of suspended filter elements to cause the pressurized air to flow downwardly and outwardly through the fabric walls of the filter elements, which dislodges the accumulated dust or particulate matter from the outer surface of the filter elements and causes it to fall to the bottom of the lower chamber of the baghouse. The pressurized air can be injected into the mouths of the filter elements either continuously or intermittently. Reverse baghouses that utilize intermittent bursts of pressurized air to clean the filter elements are commonly referred to as “reverse pulse baghouses.”

Baghouses can utilize traveling manifolds to intermittently inject pressurized air into the mouths of the filter elements, which can be known as “cleaning pulses.” For example, when a traveling manifold comes into registry with a select portion of a set array of filter elements, a cleaning pulse can be activated such that pressurized air is selectively delivered into the mouths of the respective filter elements. The pressurized air can be shut off as the manifold travels between subsequent portions of the set array of filter elements. In circular arrays of filter elements, the traveling manifold can be a rotating manifold, and the select portion of the circular array of filter elements can be geometrical sectors of the circular shape of the array.

One problem known with current rotating manifolds used to provide cleaning pulses is that the methods for bringing the rotating manifold into registry with the select sector of filter elements can lack precision and can be prone to getting out of sync. When known rotating manifolds get out of sync, the manifold will repeatedly fail to come into adequate registry with the select sector of filter elements. The lack of precision and adequate registry that arises in these situations causes the filter elements to not be adequately cleaned, which inhibits the overall performance of the baghouse by reducing or preventing the flow of dirty gas through the fabric walls of the filter elements. Further, the lack of precision and adequate registry is inefficient and results in additional costs associated with wasteful applications of pressurized air and the related energy costs. Such issues typically arise with respect to timing-based rotating manifolds that rely on set time intervals for purposes of selectively providing the cleaning pulses. With respect to timing-based rotating manifolds, the issues associated with the repeated failure to adequately come into registry with the select sector of filter elements are compounded with each revolution of the rotating manifold and over the extended operational life of the baghouse, unless manual intervention is taken. Further, some rotating manifolds may rely on reversing their rotational direction for a specific number of revolutions to counteract the lack of precision and adequate registry, but reversing the rotational direction of a rotating manifold may (i) render the rotating manifold inoperable throughout the period of reverse rotation, (ii) require reducing the rotating manifold's rotational speed before completely stopping the rotating manifold and render the rotating manifold less operable during such periods, and (iii) introduce structural strains and stresses to the materials of the rotating manifold as it repeatedly changes directions from normal rotational operations, to reverse rotational operations, and back again.

Another problem with rotating manifolds used to provide cleaning pulses is that the methods for adjusting and calibrating the rotating manifold can be difficult and time-intensive. It may be necessary to adjust and calibrate a rotating manifold after the rotating manifold is turned off or de-energized for purposes of performing maintenance on or cleaning the baghouse or its various components, or in the event of a power outage. To adjust or calibrate a rotating manifold after it has been turned off or de-energized typically requires manually moving the manifold, which may require shutting down the baghouse entirely and/or having an individual enter the baghouse. Such methods take significant time and expose the individual entering the baghouse to certain potential risks. Such issues typically arise with respect to gear-based rotating manifolds that rely on mechanical gears and gear sets for driving and positioning the rotating manifold. With respect to gear-based rotating manifolds, adjustment or calibration requires mechanically moving the rotating manifold and overcoming the mechanical forces associated therewith.

Accordingly, a need exists for an improved system of positioning and activating a rotating manifold for a reverse baghouse that more precisely injects pressurized air into the mouths of the filter elements without being prone to getting out of sync, and can be more easily adjusted or calibrated, as needed, without having an individual enter the baghouse.

### SUMMARY OF THE INVENTION

Disclosed herein is a system of positioning and activating a rotating manifold for a filtration system, such as a baghouse, that more precisely injects pressurized air into the mouths of the filter elements without being prone to getting out of sync and can be more easily adjusted or calibrated without having an individual enter the baghouse, and an associated method for operating the same.

In one embodiment, the system can generally comprise a rotating cleaning manifold, a shaft encoder, a position switch, and a controller. The rotating cleaning manifold can be adapted to sweep across a circular array of a plurality of filter elements. The shaft encoder can be configured to sense an angular position of the rotating cleaning manifold that is associated with a first sector of a plurality of sectors and output a first positional data value. The position switch can be configured to sense a complete revolution of the rotating cleaning manifold and output a second positional data value. The controller can be in communication with the shaft encoder, the position switch, and an output module and may be configured to receive the first positional data value and the second positional data value and cause the output of at least one signal based on the first positional data value and the second positional data value via the output module. The output module can be in communication with the rotating cleaning manifold to activate an intermittent cleaning pulse via the at least one signal. In one embodiment, the system can further comprise an input module in communication with the controller, wherein the input module can be configured to input at least one input value to the controller, and the controller can be configured to adjust an operational characteristic, independent of other operational characteristics, of the rotating cleaning manifold upon instruction from an operator via the at least one input value. The input module can be configured to facilitate remote operation of the rotating cleaning manifold. In another embodiment, the controller can be configured to reset a stored value related to the first positional data value. The controller can comprise at least one processing unit and can be configured to reset the stored value related to the first positional data value upon instruction from the at least one processing unit. In yet another embodiment, each sector of the plurality of sectors of the circular array of the plurality of filter elements can comprise a plurality of generally radial rows of the plurality of filter elements. In even yet another embodiment, the output module can activate the intermittent cleaning pulse relative to non-adjacent sectors of the plurality of sectors of the circular array of the plurality of filter elements.

In another embodiment, the system can generally comprise a baghouse including a rotating cleaning manifold, a shaft encoder, a position switch, and a controller. The rotating cleaning manifold can be adapted to sweep across a circular array of a plurality of filter elements. The shaft encoder can sense an angular position of the rotating cleaning manifold that is associated with a first sector of a plurality of sectors and output a first positional data value. The position switch can sense a complete revolution of the rotating cleaning manifold and output a second positional data value. The controller can be in communication with the shaft encoder, the position switch, and an output module and can receive the first positional data value and the second positional data value and cause the output of at least one signal based on the first positional data value and the second positional data value via the output module. The output module can be in communication with the rotating cleaning manifold to activate an intermittent cleaning pulse via the at least one signal. In one embodiment, the system can further comprise an input module in communication with the controller, wherein the input module can be configured to input at least one input value to the controller, and the controller can be configured to adjust an operational characteristic, independent of other operational characteristics, of the rotating cleaning manifold upon instruction from an operator via the at least one input value. The input module can be configured to facilitate remote operation of the rotating cleaning manifold. In another embodiment, the controller can be configured to reset a stored value related to the first positional data value. The controller can comprise at least one processing unit and can be configured to reset the stored value related to the first positional data value upon instruction from the at least one processing unit. In yet another embodiment, each sector of the plurality of sectors of the circular array of the plurality of filter elements can comprise a plurality of radial rows of the plurality of filter elements. In even yet another embodiment, the output module can activate the intermittent cleaning pulse relative to non-adjacent sectors of the plurality of sectors of the circular array of the plurality of filter elements.

In yet another embodiment, the method for operating the system can generally comprise the steps of sensing an angular position of a rotating cleaning manifold that is associated with a shaft encoder, sensing a complete revolution of the rotating cleaning manifold that is associated with a position switch, communicating a first positional data value and a second positional data value to a controller, and activating an intermittent cleaning pulse based on at least one signal. The shaft encoder can generate the first positional data value related to a first sector of a plurality of sectors. The position switch can generate the second positional data value. The controller can generate the at least one signal via an output module related to the first positional data value and the second positional data value. In one embodiment, the method for operating the system can further comprise the step of adjusting an operational characteristic, independent of other operational characteristics, of the rotating cleaning manifold upon instruction from an operator via an input module. The input module can be configured to facilitate remote operation of the rotating cleaning manifold. In another embodiment, the controller can be configured to reset a stored value related to the first positional data value. The method for operating the system can further comprise the step of resetting the stored value related to the first positional data value upon instruction from at least one processing unit. In yet another embodiment, the intermittent cleaning pulse can be activated relative to non-adjacent sectors of the plurality of sectors of the circular array of the plurality of filter elements.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a perspective view of a reverse pulse baghouse in accordance with one embodiment of the present invention;

FIG. 2 is a sectional elevation view of the reverse pulse baghouse of FIG. 1, illustrating a lower chamber, an upper chamber, a plurality of elongated filter elements, a rotating air tank, a rotating cleaning manifold, and other internal components of the reverse pulse baghouse in accordance with one embodiment of the present invention;

FIG. 3 is a partial perspective view of the reverse pulse baghouse of FIG. 1, represented without filter elements, further illustrating the rotating air tank, the rotating cleaning manifold, the drive system, and other internal components of the reverse pulse baghouse in accordance with one embodiment of the present invention;

FIG. 4 is a sectional elevation view of the reverse pulse baghouse of FIG. 1, represented without filter elements, further illustrating the rotating air tank, the drive system, and other internal components of the reverse pulse baghouse in accordance with one embodiment of the present invention;

FIG. 5 is a partial perspective view of the reverse pulse baghouse of FIG. 1, further illustrating a gear motor, a shaft encoder, and other internal components of the reverse pulse baghouse in accordance with one embodiment of the present invention;

FIG. 6 is a partial perspective view of the reverse pulse baghouse of FIG. 1, further illustrating a gear reducer, a position switch, an integral two-passage rotary union, a coupling, and other internal components of the reverse pulse baghouse in accordance with one embodiment of the present invention;

FIG. 7 is a partial sectional elevation view of the reverse pulse baghouse of FIG. 1, represented without filter elements, further illustrating the rotating air tank, the rotating cleaning manifold, and other internal components of the reverse pulse baghouse in accordance with one embodiment of the present invention;

FIG. 8 is a partial sectional elevation view of the reverse pulse baghouse of FIG. 1, represented without filter elements, further illustrating the rotating air tank, the rotating cleaning manifold, and other internal components of the reverse pulse baghouse in accordance with one embodiment of the present invention;

FIG. 9 is a schematic illustration of an example positioning and activation system in accordance with one embodiment of the present invention;

FIG. 10 is a schematic illustration of a portion of the positioning and activation system of FIG. 9;

FIG. 11 is a schematic illustration of an example positioning and activation system in accordance with another embodiment of the present invention;

FIG. 12 is a schematic illustration of an example positioning and activation system in accordance with yet another embodiment of the present invention;

FIG. 13 is a simplified representational top view of a tube sheet, further illustrating a representational circular array of a plurality of voids of the tube sheet arranged into radial rows of sectors of the circular array, wherein each radial row of the sector of the circular array is numbered to correspond with an associated sequence of intermittent cleaning pulses in accordance with one embodiment of the present invention;

FIG. 14 is a flow diagram of an example method that may be carried out by the positioning and activation systems of FIGS. 9-12;

FIG. 15 is a flow diagram of an example method that may be carried out by the positioning and activation system of FIG. 11; and

FIG. 16 is a flow diagram of an example method that may be carried out by the positioning and activation systems of FIGS. 9-12.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized, and changes can be made without departing from the scope of the present invention.

Referring to the figures, the present invention is directed generally to a system for cleaning filter elements of a reverse pulse baghouse by removing accumulated dust or particulate matter that has built up on the outer surface of the filter elements, and more specifically, to a positioning and activation system for a rotating cleaning manifold. As described herein, the positioning and activation system can be adapted to control a rotating cleaning manifold of a reverse pulse baghouse that precisely injects pressurized air into the mouths of the filter elements without being prone to getting out of sync, and can be easily adjusted or calibrated as needed, without having an individual enter the baghouse.

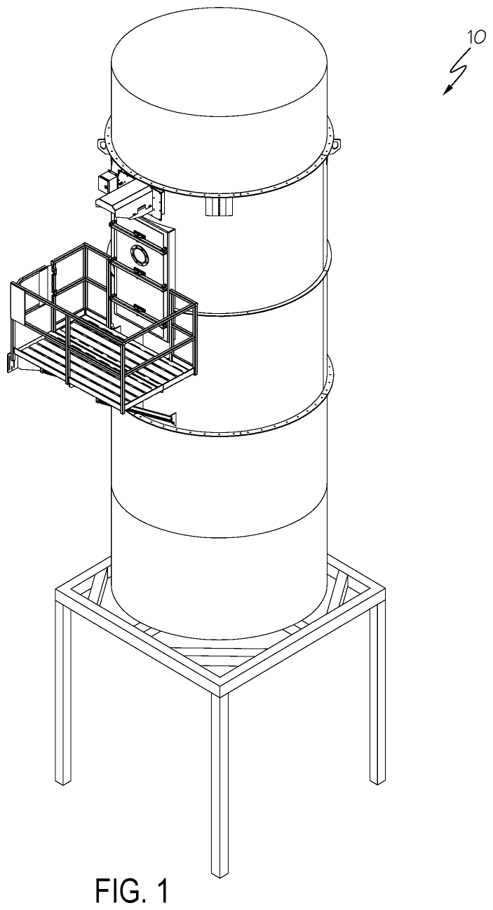

FIG. 1 illustrates a reverse pulse baghouse 10 in accordance with one embodiment of the present invention. The reverse pulse baghouse can be used to clean or purify dust-laden or particulate-laden industrial gases, known as “dirty gas,” in a variety of settings and applications. Examples of such settings and applications include, but are not limited to, industrial milling processes, food processing facilities, bulk material conveying processes, as part of pneumatic conveyance systems, air filtration systems, at coal-based power generation facilities and other power generation facilities, at hot-mix asphalt facilities, and with other commercial and industrial processes.

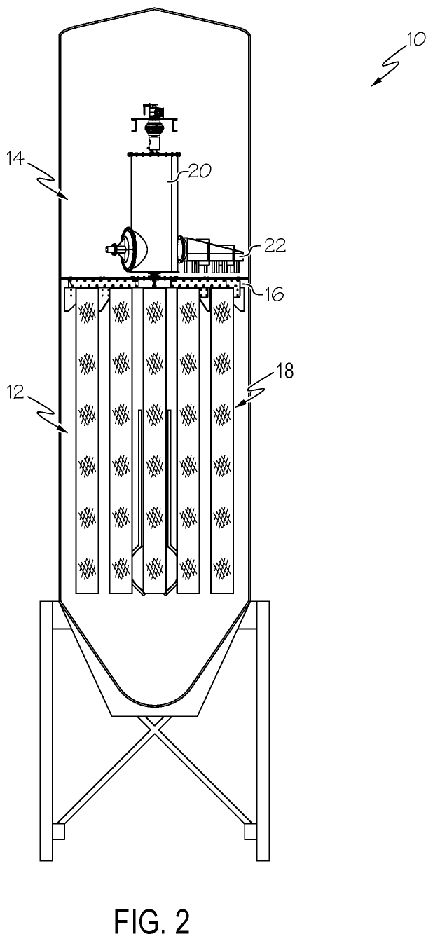

FIG. 2 provides a partial cross-sectional elevation view of a reverse pulse baghouse 10 in accordance with one embodiment of the present invention. As illustrated in FIG. 2, the reverse pulse baghouse 10 can define a lower chamber 12 and an upper chamber 14, separated by a tube sheet 16 or other suitable structure. The lower chamber 12 can be in communication with the upper chamber 14. In a preferred embodiment, a plurality of elongated filter elements 18 can be suspended from the tube sheet 16 into the lower chamber 12, such that the open ends or mouths (not shown) of the filter elements 18 can be coupled with the tube sheet 16 and in communication with the upper chamber 14. In one embodiment, the filter elements 18 can comprise a high-temperature filter media or fabric material that defines an outer surface (not shown) and an inner surface (not shown). The filter media or fabric material of the filter elements 18 can be comprised of woven, non-woven, or felted material and constructed out of cotton, nylon, polyester, fiberglass, and other suitable materials, whether presently known or later developed, and any combination thereof. A filter element 18 can further optionally comprise a wire cage reinforcement (not shown) in communication with the inner surface of the filter element 18 to hold the filter media generally taught and to maintain the overall shape of the filter element 18 during operation of the baghouse 10. During the operation of the baghouse 10, dirty gas can be pushed or drawn, via a blower or fan (not shown), into the lower chamber 12. The dirty gas can then pass through the filter media of the filter elements 18 and be delivered as clean gas to the upper chamber 14 through the mouths of the filter elements 18.

FIG. 2 further depicts a rotating air tank 20 and rotating cleaning manifold 22 in accordance with one embodiment of the present invention. As illustrated in FIG. 2, the rotating air tank 20 can be generally cylindrical in shape; however, it will be appreciated that other shapes or configurations are also within the scope of the present invention. In a preferred embodiment of the present invention, the rotating air tank 20 can be in fluid communication with the rotating cleaning manifold 22, including, without limitation, via a 90-degree reducer or other suitable means. In one embodiment, when the rotating cleaning manifold 22 is in operation, the rotating air tank 20 can be attached to the rotating cleaning manifold 22 and rotate with the rotating cleaning manifold 22 in the upper chamber 14 of the reverse pulse baghouse 10.

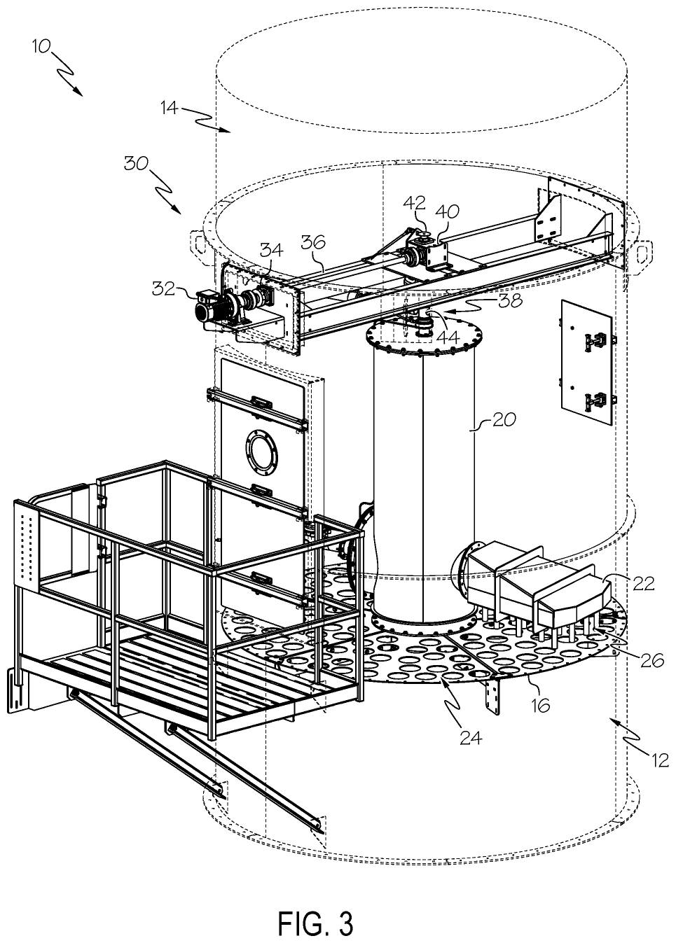

FIG. 3 provides a partial perspective view of a reverse pulse baghouse 10, illustrating the internal components thereof, in accordance with one embodiment of the present invention. As shown in FIG. 3, the reverse pulse baghouse 10 can comprise a tube sheet 16, a rotating air tank 20, a rotating cleaning manifold 22, and a drive system 30 for rotating the rotating air tank 20 and/or the rotating cleaning manifold 22. As demonstrated in FIG. 3, the tube sheet 16 can define a plurality of voids 24 that generally correspond with the mouths (not shown) of the filter elements (not shown). Each void 24 can be circular in shape, as shown in FIG. 3, and may vary in size. However, it will be understood that the voids 24 can vary in shape, and other suitable shapes of each void 24 may include triangle, elliptical, oval, square, rectangular, or a combination of shapes. As depicted in FIG. 3, the plurality of voids 24 can be arranged in a circular array and generally define radial rows of voids 24 extending generally radially from the center of the tube sheet 16 to the outer circumference or edge of the tube sheet 16. The circular array of the plurality of voids 24 and the radial rows defined by the plurality of voids 24 can correspond with the arrangement of the filter elements suspended in the lower chamber 12 of the baghouse 10, such that the filter elements can similarly be generally arranged in a circular array and can define radial rows extending generally radially from the axial center of the baghouse 10 to an inner surface (not shown) defined by an enclosure (not shown) of the reverse pulse baghouse 10. FIG. 3 further illustrates a plurality of nozzles 26 located on the rotating cleaning manifold 22. The plurality of nozzles 26 can include, without limitation, venturi nozzles and other suitable nozzles. In one embodiment, the plurality of nozzles 26 can generally correspond with, and be capable of selectively coming into registry with, a utilized number of the plurality of voids 24 independent of other portions of the plurality of voids 24, and the mouths of the filter elements corresponding therewith during operation of the rotating cleaning manifold 22. In a preferred embodiment, the utilized portion of filter elements engaged by the rotating cleaning manifold 22 and being cleaned can be associated with the angular position of the rotating cleaning manifold 22 relative to the circular array of filter elements. In one embodiment, the select utilized portion of filter elements being cleaned can comprise one radial row of filter elements. In another embodiment, the select utilized portion of filter elements being cleaned can comprise a plurality of radial rows of filter elements. However, it will be understood that the select utilized portion of filter elements being cleaned can comprise any arrangement of and/or any number of radial rows of filter elements. It will further be appreciated that the voids 24 and filter elements may not be arranged in radial rows, but instead may be arranged in other configurations or patterns. In those embodiments, the nozzles 26 located on the rotating cleaning manifold 22 may be arranged correspondingly such that they may come into registry with or index the voids 24 and filter elements as the cleaning manifold 22 is rotating.

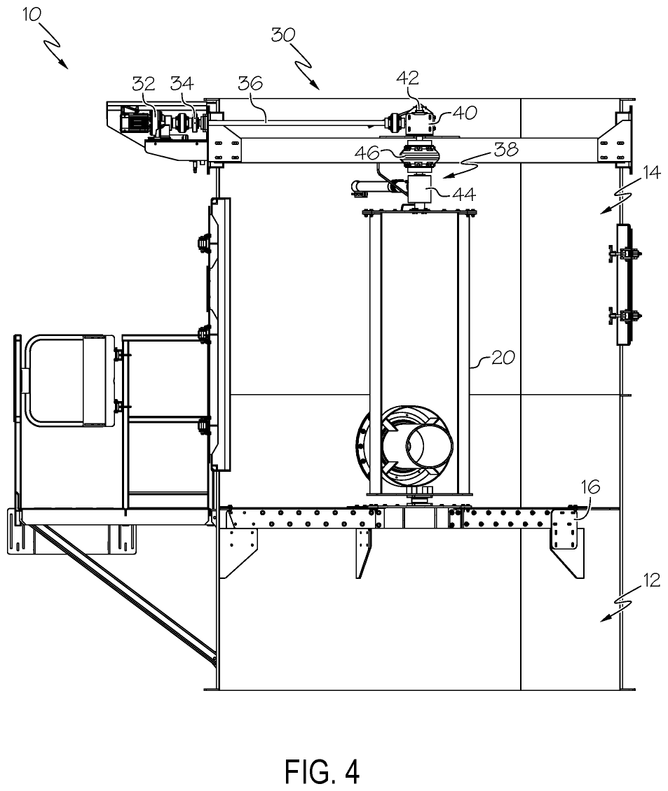

As best shown in FIG. 4, the drive system 30 can generally comprise a gear motor 32, a shaft encoder 34, a horizontal drive shaft 36, a vertical drive shaft 38, a gear reducer 40, and a position switch 42. In one embodiment, the drive system 30 can further comprise shaft couplings (not shown) and support bearings (not shown). In a preferred embodiment, the gear motor 32 can be operably coupled with and can drive the horizontal drive shaft 36, which can be operably coupled with and can drive the vertical drive shaft 38 via the gear reducer 40, a right-angle gearbox, or other suitable mechanism. The vertical drive shaft 38 can further be operably coupled with and drive the rotating air tank 20 and/or the rotating cleaning manifold (not shown in FIG. 4). In another embodiment, the vertical drive shaft 38 can be operably coupled with an integral two-passage rotary union 44. The integral two-passage rotary union 44 can be adapted so that the vertical drive shaft 38 can drive the integral two-passage rotary union 44, which can be operably coupled with and can drive the rotating of the rotating air tank 20 and/or the rotating cleaning manifold. The integral two-passage rotary union 44 can be further adapted to provide an operable interface between stationary fluid sources and rotating destinations for such fluid or fluids. The subject fluids can include, without limitation, pressurized air, pneumatic gases, or hydraulic fluids. In one embodiment, the integral two-passage rotary union 44 can permit a stationary positive displacement blower (not shown) to introduce pressurized air into the rotating air tank 20. In another embodiment, the integral two-passage rotary union 44 can permit a stationary diaphragm activation valve (not shown) to actuate, either pneumatically or hydraulically, a valve or set of valves (not shown) coupled with the rotating air tank 20 and/or the rotating cleaning manifold so that pressurized air contained within the rotating air tank 20 can be selectively injected into the mouths of the filter elements via the plurality of nozzles (not shown in FIG. 4) of the rotating cleaning manifold.

As illustrated in FIG. 4, the drive system 30 can further comprise at least one coupling 46 that may include, without limitation, a Dodge Raptor coupling or other suitable coupling. As further illustrated in FIG. 4, the gear reducer 40, the integral two-passage rotary union 44, and the coupling 46 can be axially and/or vertically aligned with the rotating air tank 20.

The drive system 30 can further comprise a variable frequency drive (not shown), which can be used to power the gear motor 32 and allow for varying and selectively adjustable rotational speeds of the rotating air tank 20 and/or the rotating cleaning manifold 22 via the gear motor 32, the horizontal drive shaft 36, and/or the vertical drive shaft 38. The varying and selectively adjustable rotational speeds of the rotating air tank 20 and/or the rotating cleaning manifold 22 can allow for selective cleaning of a certain filter element or plurality of filter elements, which may be achieved by adjusting the frequency of the cleaning pulses and the pressure of the cleaning pulses.

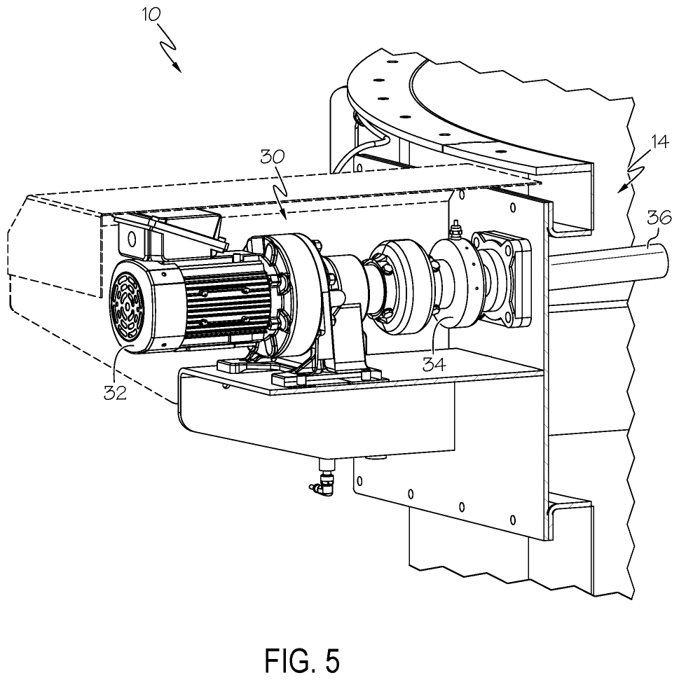

As best shown in FIG. 5, the shaft encoder 34 can be coupled with the horizontal drive shaft 36 to sense or detect the absolute angular position of the rotating cleaning manifold (not shown in FIG. 5). In other embodiments, the shaft encoder 34 can be coupled with the vertical drive shaft (not shown in FIG. 5), any other component of the drive system 30, the rotating cleaning manifold, or any other component of the baghouse 10. In one embodiment, the shaft encoder 34 can be a device adapted to sense or detect an absolute angular position of a rotating shaft and converting the angular position to a desired output. In a preferred embodiment, the shaft encoder 34 can be adapted for sensing or detecting the angular position of the rotating cleaning manifold as it travels or sweeps across a circular array of filter elements of a reverse pulse baghouse 10. Sensing or detecting the angular position of the rotating cleaning manifold can ensure adequate registry of the rotating cleaning manifold with the utilized number of filter elements (not shown) for purposes of precisely injecting pressurized air into the mouths of the filter elements. The shaft encoder 34 of the present invention can be a mechanical encoder, an optical encoder, a magnetic encoder, or other suitable encoder, whether presently known or later developed. The shaft encoder 34 can have a resolution between about 0.009 degrees per pulse and about 1 degree per pulse in one embodiment, between about 0.036 degrees per pulse and about 0.33 degrees per pulse in another embodiment, and about 0.15 degrees per pulse in yet another embodiment.

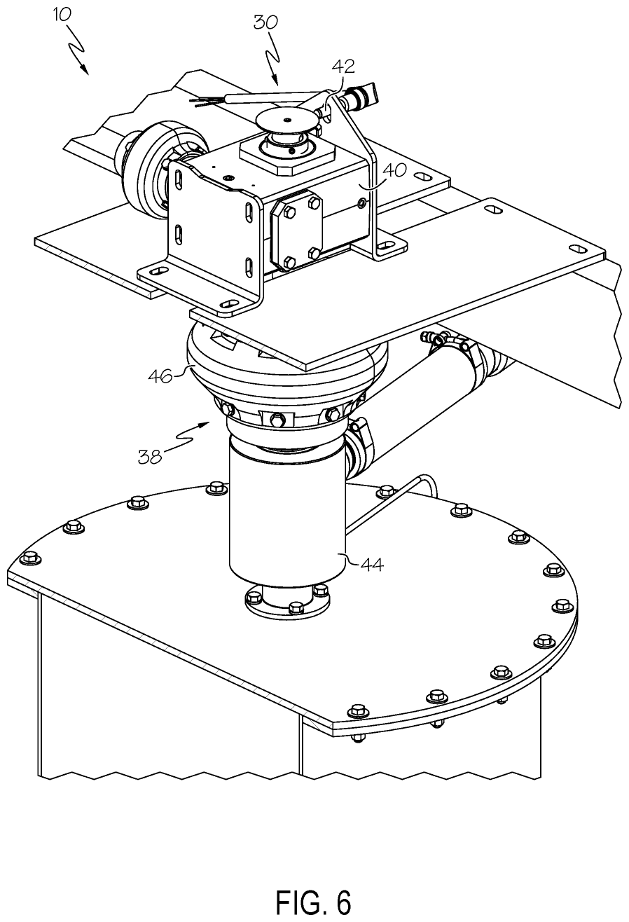

As best shown in FIG. 6, the position switch 42 can be coupled with the vertical drive shaft 38 via the gear reducer 40 to sense or detect complete revolutions of the rotating cleaning manifold (not shown in FIG. 6). In other embodiments, the position switch 42 can be coupled with the horizontal drive shaft (not shown in FIG. 6), any other component of the drive system 30, the rotating cleaning manifold, or any other component of the baghouse 10. In one embodiment, the position switch 42 can be a device adapted to sense or detect a complete revolution of a rotating shaft and converting the revolution count to a desired output. In a preferred embodiment, the position switch 42 can be adapted for sensing or detecting the complete revolution of the rotating cleaning manifold as it travels or sweeps across a circular array of filter elements (not shown) of a reverse pulse baghouse 10. The position switch 42 of the present invention can be an electronic position switch, a mechanical position switch, a pressure switch, or other suitable position switches, whether presently known or later developed.

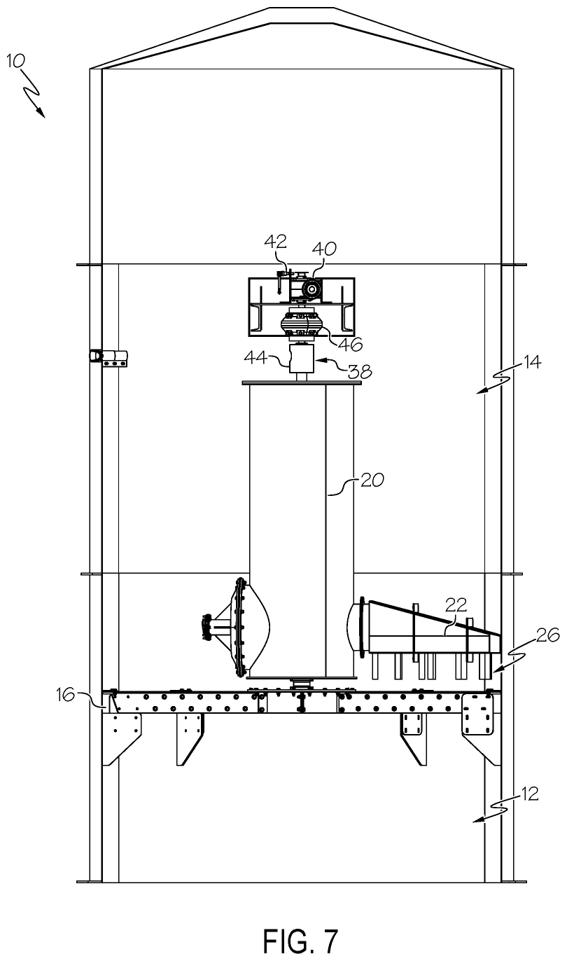

FIG. 7 provides a partial sectional elevation view of a reverse pulse baghouse 10 in accordance with one embodiment of the present invention. As illustrated in FIG. 7, the rotating cleaning manifold 22 can generally extend across the entire circular radius of the tube sheet 16 so that it can come into registry with all filter elements (not shown) along the length of the utilized portion of filter elements.

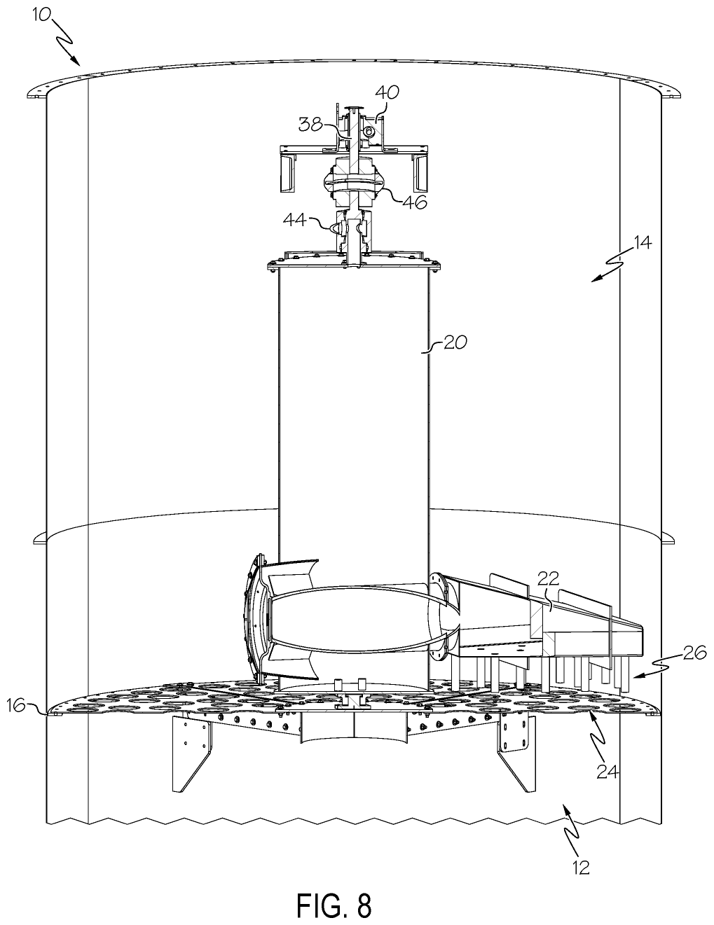

FIG. 8 provides a partial cross-sectional elevation view of a reverse pulse baghouse 10 in accordance with one embodiment of the present invention. As best illustrated in FIG. 8, the rotating air tank 20 can be coupled and in fluid communication with the rotating cleaning manifold 22. FIG. 8 further depicts the gear reducer 40, the integral two-passage rotary union 44, and the coupling 46 of the drive system 30. Further, FIG. 8 illustrates that the plurality of nozzles 26 can generally correspond with and be capable of selectively coming into registry with a utilized number of the plurality of voids 24, independent of other portions of the plurality of voids 24, and the mouths of the filter elements (not shown) corresponding therewith during operation of the rotating cleaning manifold 22.

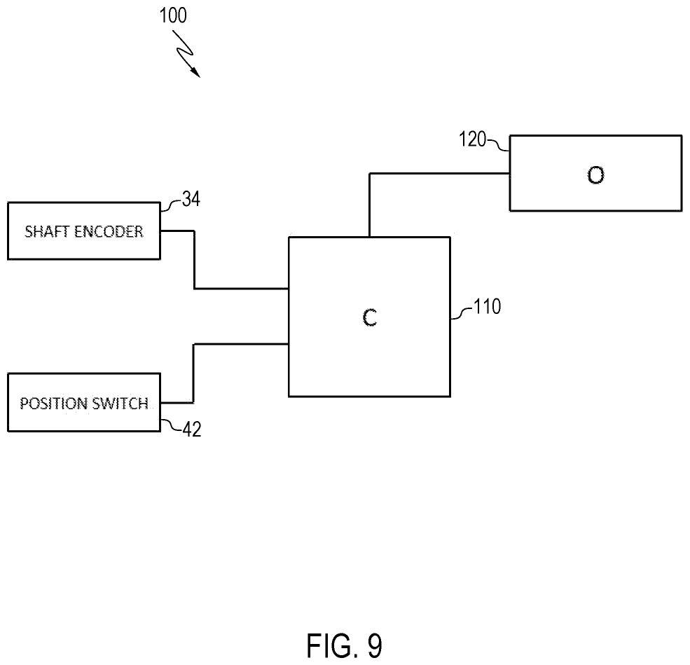

FIG. 9 provides a schematic representation of a positioning and activation system 100 in accordance with one embodiment of the present invention. The positioning and activation system 100 can be adapted for use with a rotating cleaning manifold 22 of a reverse pulse baghouse 10. As illustrated in FIG. 9, the positioning and activation system 100 can generally comprises a shaft encoder 34, a position switch 42, a controller 110, and an output module 120. The shaft encoder 34 and the position switch 42 can be in communication with the controller 110, and the controller 110 can be in communication with the output module 120.

The shaft encoder 34 can be adapted for generating a first positional data value as a desired output. In a preferred embodiment, the shaft encoder 34 can be in communication with the controller 110 and can communicate the first positional data value to the controller 110. The first positional data value can correspond with a count value associated with a certain number of geometrical sectors of the circular shape of the utilized circular array of filter elements 18 engaged and/or traveled by the rotating cleaning manifold 22. In one embodiment, the first positional data value can relate to an individual sector of a plurality of sectors, independent of other sectors of the plurality of sectors, of a utilized circular array of filter elements 18 engaged by the rotating cleaning manifold 22 related to the sensed or detected angular position of the rotating cleaning manifold 22. In another embodiment, the shaft encoder 34 may be reset after each complete revolution of the rotating cleaning manifold 22 to improve the accuracy of the first positional data value. In one embodiment, a counter may be utilized to determine the pulse positions and reset the pulse position sequence at a defined frequency (e.g., after every third revolution).

The position switch 42 can be adapted for generating a second positional data value as a desired output. In a preferred embodiment, the position switch 42 can be in communication with the controller 110 and can communicate the second positional data value to the controller 110. The second positional data value can correspond with a count value associated with a number of complete revolutions completed by the rotating cleaning manifold 22 as it travels or sweeps across a circular array of filter elements 18.

The controller 110 can be a device adapted to receive various inputs, generate desired outputs, and control various devices. The controller 110 can be in communication with and generally control the baghouse 10; the rotating air tank 20; the rotating cleaning manifold 22; the drive system 30 and any component thereof, including the gear motor 32, the horizontal drive shaft 36, the vertical drive shaft 38, the gear reducer 40, and the variable frequency drive; and/or the positioning and activation system 100 and any component thereof. In a preferred embodiment, the controller 110 can adjust certain operational characteristics of the baghouse 10 and/or the rotating cleaning manifold 22. Such operational characteristics may include, without limitation, starting or stopping the baghouse 10; speeding up, slowing down, or stopping the rotating cleaning manifold 22 or one or more elements thereof; resetting the angular position of the rotating cleaning manifold 22 to a predefined zero point; outputting a signal to an external source; or any other suitable or desired adjustment to the baghouse 10 and/or the rotating cleaning manifold 22. Adjusting the operational characteristics can be done while the baghouse 10 and/or the rotating cleaning manifold 22 are in operation. Further, adjusting such operational characteristics can allow for the baghouse 10, rotating cleaning manifold 22, and/or the positioning and activation system 100 to be fine-tuned for purposes precisely injecting pressurized air into the mouths of a utilized portion of filter elements 18 and ensure that the rotating cleaning manifold 22 remains in sync.

The predefined zero point can be an absolute starting angular position for the rotating cleaning manifold 22, which can be set at the time of installation of the rotating cleaning manifold 22 or subsequently established by an operator of the positioning and activation system 100. In a preferred embodiment, resetting the angular position of the rotating cleaning manifold 22 to the predefined zero point can be achieved with predefined code or software stored in a memory and without manually moving the rotating cleaning manifold 22 or requiring an individual to enter the baghouse 10. The amount of time necessary to reset the rotating cleaning manifold 22 to the predefined zero point can take approximately between about ten seconds and about two minutes in one embodiment, and about twenty seconds in another embodiment.

The output module 120 can be a device adapted to provide, upon instruction from the controller 110, at least one signal or output. In one embodiment, at least one signal generated by the output module 120 can be a digital or audible indication to an operator. In another embodiment, at least one signal generated by the output module 120 can be an electronic instruction to another device in communication with the output module, such as a gear motor 32 or at least one processing unit. At least one signal provided by the output module 120 can be received by a device, computer, or processor for purposes of manually or automatically adjusting one or more of the operational characteristics of the baghouse 10 or the rotating cleaning manifold 22.

In one embodiment, the output module 120 can further include a display screen (not shown). The display screen can comprise a device by which information can be instantaneously and visually presented to an operator of the baghouse 10 or the rotating cleaning manifold 22 or to a remotely-located monitor, manager, or operator of the baghouse 10 or the rotating cleaning manifold 22. For example, the display screen can provide visual feedback, including, without limitation, real-time indications of the operational characteristics of the baghouse 10, the rotating air tank 20, the rotating cleaning manifold 22, and/or the positioning and activation system 100. The real-time indications can include, without limitation, the air pressure within the rotating air tank 20, the position of the rotating cleaning manifold 22, when an intermittent cleaning pulse or burst of pressurized air has been activated, and other operational characteristics. Further, the display may comprise a monitor or screen that is stationary in nature or that is mobile in nature. A mobile display can be a computer tablet, smart phone, personal data assistant (“PDA”), and/or the like.

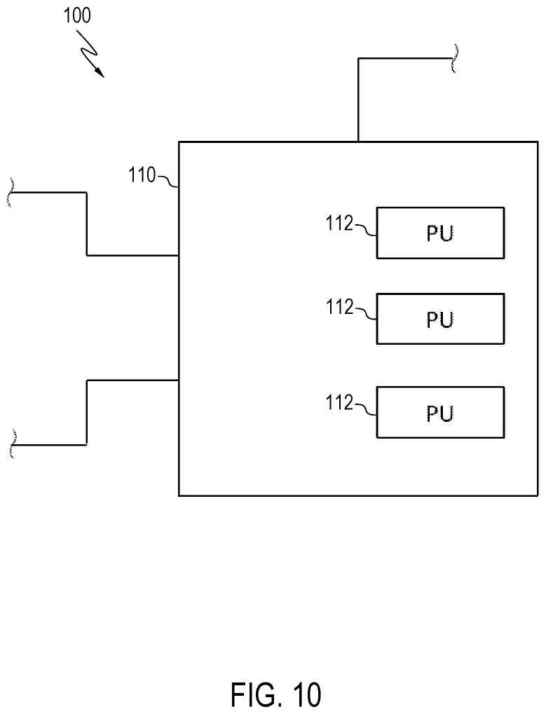

As best illustrated in FIG. 10, in one embodiment of the present invention, the controller 110 can generally comprise at least one processing unit 112 configured to carry out instructions either hardwired as part of an application-specific integrated circuit or provided as code or software stored in a memory. In another embodiment, at least one processing unit 112 can be in communication with a memory.

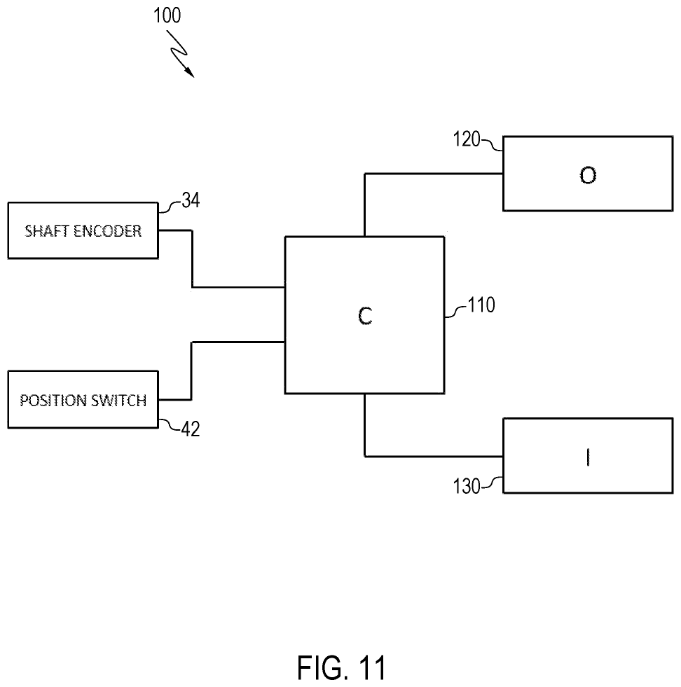

As best illustrated in FIG. 11, in another embodiment of the present invention, the positioning and activation system 100 can further comprise an input module 130 that can be in communication with the controller 110. The controller 110 can be configured to be instructed or directed by an individual or an operator via the input module 130, or in some similar manner. Further, the input module 130 can be configured to adjust, upon instruction or direction of an individual or an operator, one or more operational characteristics of the baghouse 10; the rotating air tank 20; the rotating cleaning manifold 22; the drive system 30 and any component thereof, including the gear motor 32, the horizontal drive shaft 36, the vertical drive shaft 38, the gear reducer 40, and the variable frequency drive; and/or the positioning and activation system 100 and any component thereof. The input module 130 can comprise one or more devices by which controls, and input may be provided to the controller 110, such as a keyboard, touchpad, touch screen, control, joystick, microphone with associated speech recognition software, and/or the like. The input module 130 can be configured to facilitate remote operation when the rotating cleaning manifold 22 is configured to be remotely controlled.

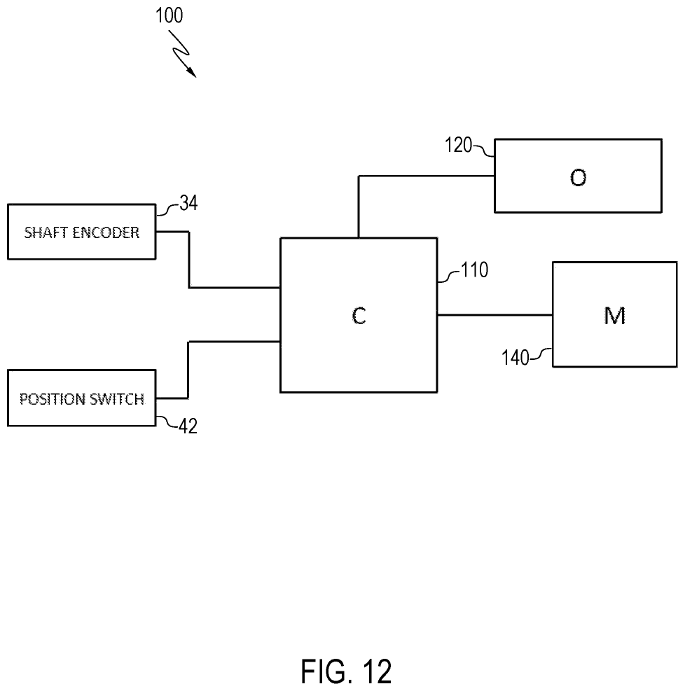

As best illustrated in FIG. 12, in another embodiment of the present invention, the positioning and activation system 100 can further comprise a memory 140 that can be in communication with the controller 110. The controller 110 can be configured to be instructed or directed by the memory 140, or in some similar manner. The memory 140 can comprise a non-transient computer-readable medium or persistent storage device for storing data or other information for use by the positioning and activation system 100 or generated by the shaft encoder 34, the position switch 42, the controller 110, and/or at least one processing unit 112. In one embodiment, the memory 140 can store the value or cumulative values of the first positional data values generated by the shaft encoder 34 and the second positional data value generated by the position switch 42. In another embodiment, the memory 140 can store instructions in the form of code or software for the controller 110 and/or at least one processing unit 112. The memory 140 can be provided with the controller 110 and/or at least one processing unit 112, or it can be provided remote from the controller 110 and/or at least one processing unit 112. In yet another embodiment, the memory 140 can comprise a plurality of modules or databases that contain various data values.

In a preferred embodiment, the positioning and activation system 100 and/or the controller 110 can be adapted for activating a sequence of intermittent cleaning pulses or bursts of pressurized air from the plurality of nozzles 26 of the rotating cleaning manifold 22, wherein the bursts of pressurized air can be injected into the mouths of the filter elements 18 for purposes of cleaning the filter elements 18. In a preferred embodiment, the controller 110 and/or the output module 120 can be in communication with an electric solenoid valve, which is in communication a diaphragm activation valve. When the value of the first positional data value generated by the shaft encoder 34, or the cumulative values of the first positional data values generated by the shaft encoder 34, equals or exceeds a predetermined value, the controller 110 can cause the diaphragm activation valve to be activated via at least one signal. The diaphragm activation valve can then actuate, either pneumatically or hydraulically, a valve or set of valves coupled with the rotating air tank 20 and/or the rotating cleaning manifold 22. By doing so, the controller 110 and/or the output module 120, via at least one signal, the diaphragm activation valve, and the valve or set of valves coupled with the rotating air tank 20 and/or the rotating cleaning manifold 22, can selectively activate an intermittent cleaning pulse that injects pressurized air into the mouths of the filter elements 18 from the plurality of nozzles 26 of the rotating cleaning manifold 22. In a further embodiment, the diaphragm activation valve can be in communication with an integral diaphragm valve coupled with the rotating air tank 20, and when the diaphragm activation valve actuates the integral diaphragm valve, it causes the rotating air tank 20 to release a burst of pressurized air into the rotating cleaning manifold 22 to be injected into the mouths of the filter elements 18 via the plurality of nozzles 26.

The sequence of intermittent cleaning pulses can relate to the total number of individual sectors of the circular shape of a circular array of filter elements 18 of a reverse pulse baghouse 10. In one embodiment, the sequence of intermittent cleaning pulses can be associated with adjacent sectors of the circular array of filter elements 18. That is, every time that the rotating cleaning manifold 22 corresponds with or comes into registry with a sector of the circular array of filter elements 18 as it travels or sweeps across the circular array, a cleaning pulse can be activated, and pressurized air injected into the mouths of the filter elements 18. In another embodiment, the sequence of intermittent cleaning pulses can be associated with non-adjacent sectors of a circular array of filter elements 18. That is, once an intermittent cleaning pulse has been activated relative to a first sector of the circular array of filter elements 18, the rotating cleaning manifold 22 can continue to travel or sweep across the circular array without a subsequent intermittent cleaning pulse being activated until the rotating cleaning manifold 22 has reached either a second sector to be engaged by the rotating cleaning manifold 22 or a predetermined angular position based on a sector count related to a number of individual sectors traveled by the rotating cleaning manifold 22 between consecutive intermittent cleaning pulses. The sector count can be associated with every other individual sector, every third individual sector, or every fourth individual sector of the circular array of filter elements 18. However, it will be understood that the sector count can be associated with any integer number of individual sectors of a circular array of filter elements 18.

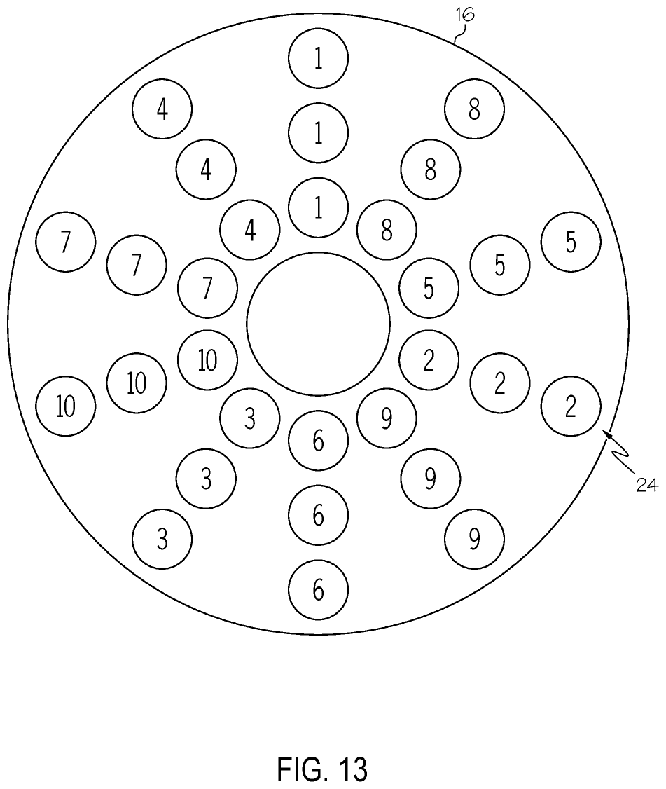

FIG. 13 provides a simplified representation of a circular array of a plurality of voids 24 of a tube sheet 16 associated with a circular array of filter elements (not shown). In FIG. 13, the voids 24 are arranged into radial rows representative of individual sectors of the circular array. The voids 24 of the respective individual sectors in FIG. 13 have been marked with increasing integers from 1 to 10, in a clockwise manner, to represent the ordered sequence of intermittent cleaning pulses according to one embodiment of the present invention. In particular, the number of individual sectors represented in FIG. 13 is ten, and the sector count for the sequence of intermittent cleaning pulses equals every third individual sector of the circular array. In this embodiment, a cleaning pulse can be activated every third individual sector as the rotating cleaning manifold (not shown) travels or sweeps across the circular array in a clockwise manner. However, it will be understood that the sector count can be associated with any integer number of individual sectors of a circular array of filter elements.

The sequence of intermittent cleaning pulses and/or the sector count between subsequent intermittent cleaning pulses can generally relate to the amount of time necessary for the rotating cleaning manifold 22 to travel between individual utilized sectors of the circular array of filter elements 18 and/or the amount of time necessary to adequately recharge the pressurized air contained in the rotating air tank 20. In one embodiment, the drive system 30 can comprise a variable frequency drive that can be used to varyingly and selectively adjust the rotational speeds of the rotating air tank 20 and/or the rotating cleaning manifold 22 during operation. The varying and selective adjustments to the rotational speeds of the rotating air tank 20 and/or the rotating cleaning manifold 22 can allow for selective cleaning pulses to be activated relative to certain predetermined filter elements 18 or sectors of the circular array of filter elements 18. In another embodiment, the varying and selective adjustments to the rotational speeds of the rotating air tank 20 and/or the rotating cleaning manifold 22 can allow for the pressurized air contained in the rotating air tank 20 to adequately recharge without skipping individual sectors of a circular array of filter elements 18 or stopping the rotation of the rotating cleaning manifold 22.

In a preferred embodiment, after the second positional data value generated by the position switch 42 equals or exceeds a predetermined value, the controller 110 can reset any stored value related to the first positional data value generated by the shaft encoder 34. Resetting a stored value related to the first positional data value can have the effect of zeroing out the associated positional data related to the angular position of the rotating cleaning manifold 22. Further, resetting stored value related to the first positional data value can ensure that the rotating cleaning manifold 22 stays in sync and continues to precisely inject intermittent bursts of pressurized air into the mouths of the filter elements 18 without stopping the rotation of or reversing the rotational direction of the rotating cleaning manifold 22. In one embodiment, when the number of individuals sectors of a circular array of filter elements 18 equals ten and the sector count for the sequence of intermittent cleaning pulses equals every third individual sector of the circular array, the controller 110 can reset the cumulative values of the first positional data values generated by the shaft encoder 34 once the second positional data value generated by the position switch 42 equals or exceeds three. Said differently, once the position switch 42 accounts for three complete revolutions of the rotating cleaning manifold 22, the angular position-related data associated with the first positional data value can be reset so that the positioning and activation system 100 can restart the sequence of intermittent cleaning pulses and ensure that the rotating cleaning manifold 22 stays in sync. However, it will be understood that the number of individuals sectors of the circular array of filter elements 18 can equal any suitable number, and the sector count for the sequence of intermittent cleaning pulses can be any number associated with adjacent and non-adjacent individual sectors.

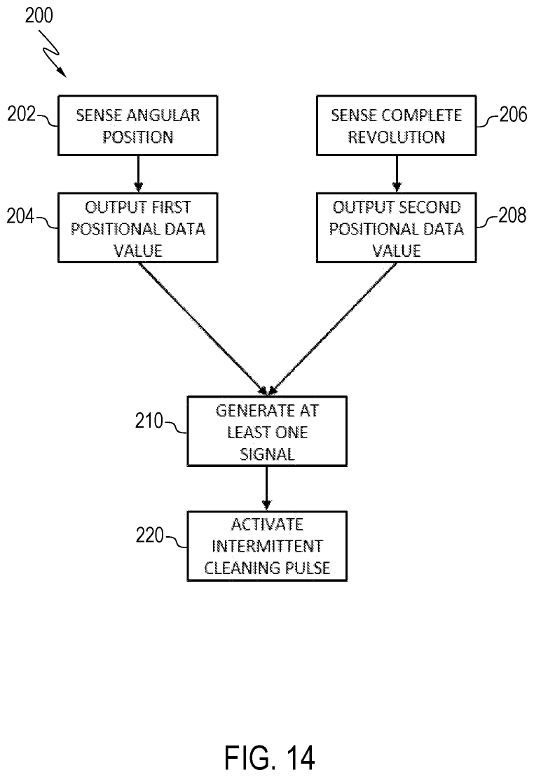

FIG. 14 is a diagram depicting an example method 200 for positioning and activating a rotating cleaning manifold 22 of a reverse pulse baghouse 10 that may be carried out in conjunction with the positioning and activation system 100 in accordance with one embodiment of the present invention. As indicated by block 202, a shaft encoder 34 can sense or detect the angular position of the rotating cleaning manifold 22. Block 204 illustrates how the shaft encoder 34 can generate a first positional data value related to a first sector of a plurality of sectors, independent of other sectors of the plurality of sectors, of a utilized circular array of a plurality of filter elements 18 currently engaged by the rotating cleaning manifold 22 with respect to the angular position of the rotating cleaning manifold 22. As indicated by block 206, a position switch 42 can sense or detect the compete revolution of the rotating cleaning manifold 22. Block 208 illustrates how the position switch 42 can generate a second positional data value related to the compete revolution of the rotating cleaning manifold 22. Block 210 illustrates how a controller 110 can receive the first positional data value from the shaft encoder 34 and the second positional data value from the position switch 42 and can cause at least one signal to be generated that relates to the first positional data value and the second positional data value. As illustrated by block 220, at least one signal can be used to activate an intermittent cleaning pulse of the rotating cleaning manifold 22.

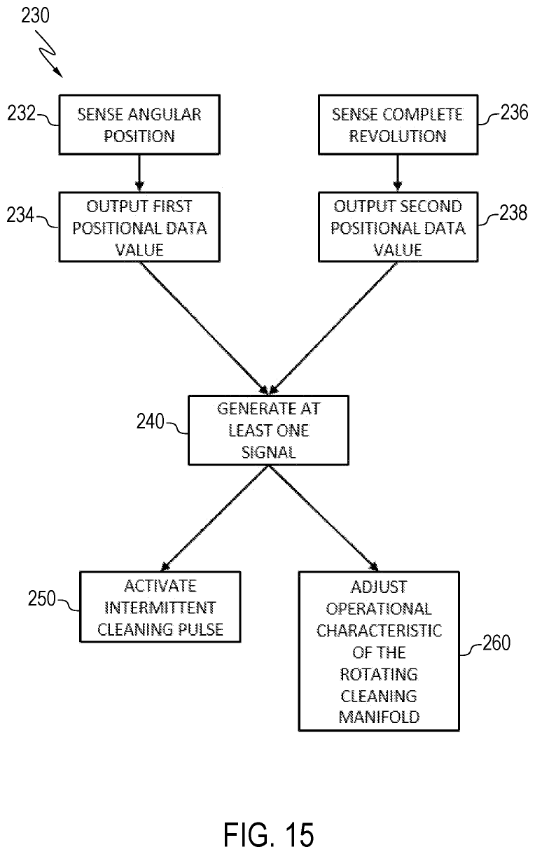

FIG. 15 is a diagram depicting an example method 230 for positioning and activating a rotating cleaning manifold 22 of a reverse pulse baghouse 10 that may be carried out in conjunction with the positioning and activation system 100 in accordance with one embodiment of the present invention. As indicated by block 232, a shaft encoder 34 can sense or detect the angular position of the rotating cleaning manifold 22. Block 234 illustrates how the shaft encoder 34 can generate a first positional data value related to a first sector of a plurality of sectors, independent of other sectors of the plurality of sectors, of a utilized circular array of a plurality of filter elements 18 currently engaged by the rotating cleaning manifold 22 with respect to the angular position of the rotating cleaning manifold 22. As indicated by block 236, a position switch 42 can sense or detect the compete revolution of the rotating cleaning manifold 22. Block 238 illustrates how the position switch 42 can generate a second positional data value related to the compete revolution of the rotating cleaning manifold 22. Block 240 illustrates how a controller 110 can receive the first positional data value from the shaft encoder 34 and the second positional data value from the position switch 42 and can cause at least one signal to be generated that relates to the first positional data value and the second positional data value. As illustrated by block 250, at least one signal can be used to activate an intermittent cleaning pulse of the rotating cleaning manifold 22. Block 260 illustrates how an operator can adjust an operational characteristic, independent of other operational characteristics, of the rotating cleaning manifold 22 via an input module 130 in communication with the controller 110. In one embodiment, the operational characteristics can relate to the angular position of the rotating cleaning manifold 22. In another embodiment, the controller 110 can be configured to reset the rotating cleaning manifold 22 to a predefined zero point.

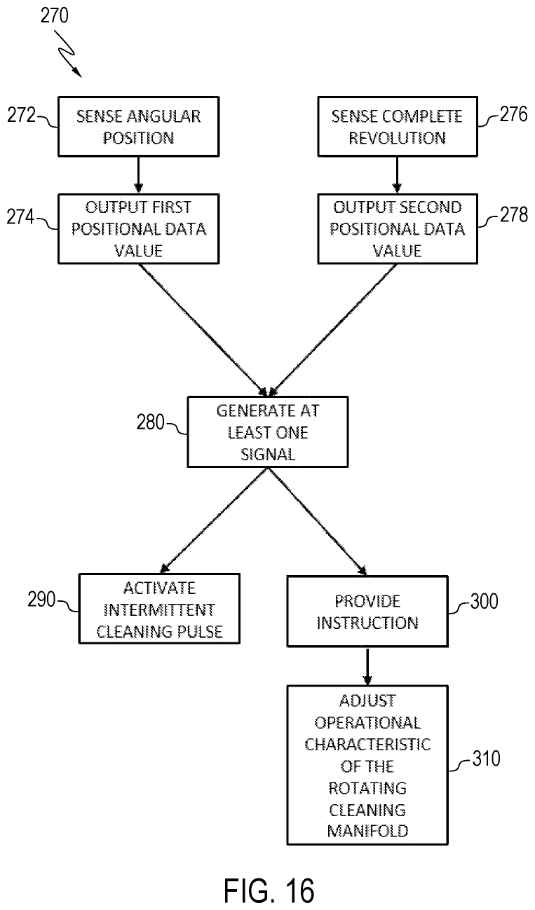

FIG. 16 is a diagram depicting an example method 270 for positioning and activating a rotating cleaning manifold 22 of a reverse pulse baghouse 10 that may be carried out in conjunction with the positioning and activation system 100 in accordance with one embodiment of the present invention. As indicated by block 272, a shaft encoder 34 can sense or detect the angular position of the rotating cleaning manifold 22. Block 274 illustrates how the shaft encoder 34 can generate a first positional data value related to a first sector of a plurality of sectors, independent of other sectors of the plurality of sectors, of a utilized circular array of a plurality of filter elements 18 currently engaged by the rotating cleaning manifold 22 with respect to the angular position of the rotating cleaning manifold 22. As indicated by block 276, a position switch 42 can sense or detect the compete revolution of the rotating cleaning manifold 22. Block 278 illustrates how the position switch 42 can generate a second positional data value related to the compete revolution of the rotating cleaning manifold 22. Block 280 illustrates how a controller 110 can receive the first positional data value from the shaft encoder 34 and the second positional data value from the position switch 42 and can cause at least one signal to be generated that relates to the first positional data value and the second positional data value. As illustrated by block 290, at least one signal can be used to activate an intermittent cleaning pulse of the rotating cleaning manifold 22. Block 300 illustrates how at least one processing unit 112 can receive at least one signal and provide instruction to adjust an operational characteristic, independent of other operational characteristics, of the rotating cleaning manifold 22. In one embodiment, the operational characteristics can relate to the angular position of the rotating cleaning manifold 22. In another embodiment, the controller 110 can be configured to reset the rotating cleaning manifold 22 to a predefined zero point.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A system for operating a rotating cleaning manifold that sweeps across an array of a plurality of filter elements, comprising:
a shaft encoder configured to:
sense an angular position of the rotating cleaning manifold that is associated with a first sector of a plurality of sectors of the array; and
output a first positional data value;
a position switch configured to:
sense a complete revolution of the rotating cleaning manifold; and
output a second positional data value;
a controller in communication with the shaft encoder, the position switch, and an output module, the controller configured to:
receive the first positional data value and the second positional data value; and
cause the output of at least one signal based on the first positional data value and the second positional data value via the output module;
wherein the output module is in communication with the rotating cleaning manifold to activate an intermittent cleaning pulse via the at least one signal.

2. The system of claim 1, further comprising:
an input module in communication with the controller;
wherein the input module is configured to input at least one input value to the controller;
wherein the controller is configured to adjust an operational characteristic, independent of other operational characteristics, of the rotating cleaning manifold upon instruction from an operator via the at least one input value.

3. The system of claim 2, wherein the input module is configured to facilitate remote operation of the rotating cleaning manifold.

4. The system of claim 1, wherein the controller is configured to reset a stored value related to the first positional data value.

5. The system of claim 4, wherein the controller comprises at least one processing unit and the controller is configured to reset the stored value related to the first positional data value upon instruction from the at least one processing unit.

6. The system of claim 1, wherein the array is a circular array.

7. The system of claim 1, wherein each sector of the plurality of sectors of the array comprises a plurality of radial rows of filter elements.

8. The system of claim 1, wherein the output module activates the intermittent cleaning pulse relative to non-adjacent sectors of the plurality of sectors of the array of filter elements.

9. A filtration system comprising:
a rotating cleaning manifold configured to sweep across an array of a plurality of filter elements;
a shaft encoder configured to:
sense an angular position of the rotating cleaning manifold that is associated with a first sector of a plurality of sectors of the array; and
output a first positional data value;
a position switch configured to:
sense a complete revolution of the rotating cleaning manifold; and
output a second positional data value;
a controller in communication with the shaft encoder, the position switch, and an output module, the controller configured to:
receive the first positional data value and the second positional data value; and
cause the output of at least one signal based on the first positional data value and the second positional data value via the output module;
wherein the output module is in communication with the rotating cleaning manifold to activate an intermittent cleaning pulse via the at least one signal.

10. The system of claim 9, further comprising:
an input module in communication with the controller;
wherein the input module is configured to input at least one input value to the controller;
wherein the controller is configured to adjust an operational characteristic, independent of other operational characteristics, of the rotating cleaning manifold upon instruction from an operator via the at least one input value.

11. The system of claim 9, wherein each sector of the plurality of sectors of the array comprises a plurality of radial rows of filter elements.

12. The system of claim 9, wherein the output module activates the intermittent cleaning pulse relative to non-adjacent sectors of the plurality of sectors of the array of filter elements.

13. The system of claim 9, wherein the filtration system is a baghouse filtration system.

14. The system of claim 9, wherein the filtration system is a reverse pulse baghouse filtration system.

15. A method for operating a rotating cleaning manifold that sweeps across an array of a plurality of filter elements, the method comprising the steps of:
sensing an angular position of the rotating cleaning manifold that is associated with a shaft encoder, the shaft encoder generating a first positional data value related to a first sector of a plurality of sectors;
sensing a complete revolution of the rotating cleaning manifold that is associated with a position switch, the position switch generating a second positional data value;
communicating the first positional data value and the second positional data value to a controller, the controller generating at least one signal via an output module related to the first positional data value and the second positional data value; and
activating an intermittent cleaning pulse based on the at least one signal.

16. The method of claim 15 further comprising the step of adjusting an operational characteristic, independent of other operational characteristics, of the rotating cleaning manifold upon instruction from an operator via an input module.

17. The method of claim 16, wherein the input module is configured to facilitate remote operation of the rotating cleaning manifold.

18. The method of claim 15, wherein the controller is configured to reset a stored value related to the first positional data value.

19. The method of claim 18 further comprising the step of resetting the stored value related to the first positional data value upon instruction from at least one processing unit.

20. The method of claim 15, wherein the intermittent cleaning pulse is activated relative to non-adjacent sectors of the plurality of sectors of the array of filter elements.
